(19) United States
(12) Patent Application Publication
(10) Pub. No.: US 2009/0327147 A1
(43) Pub. Date: Dec. 31, 2009

(54) SYSTEM AND METHOD OF STRATEGIC COALITION BUILDING AND MATCHING FOR BUSINESS SERVICES

(76) Inventors: Parijat Dube, Yorktown Heights, NY (US); Karthik Subbian, Pondicherry (IN); Laura Wynter, Chappaqua, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/147,252

(22) Filed: Jun. 26, 2008

(51) Int. Cl. G06Q 99/00; G06Q 10/00

(52) U.S. Cl. 705/80; 705/1; 705/7

(57) ABSTRACT

A computerized method (and apparatus) for coalition formation. One or more coalitional and/or service constraints are received and a feedback mechanism is provided for the coalition formation, as based on the coalitional and/or service constraints.

### BACKGROUND OF THE INVENTION

1. Field of the Invention

The present invention generally relates to the formation of coalitions, particularly in e-commerce, among buyers and sellers. More specifically, a feedback mechanism permits initially-proposed constraints to be selectively relaxed to formulate a coalition that is more optimal in at least one aspect.

2. Description of the Related Art

The electronic marketplaces and exchanges have seen exponential growth in the last decade. Yet, the tools available for market players (e.g., buyers and sellers) are limited to exploit the market opportunities.

The growth of new collaborative tools along with Web 2.0 has given rise to new collaborative opportunities, and a new dimension to collaborative electronic trading. In the recent past there has been reviving interest in the e-market community to group similarly interested buyers and sellers, using such collaboration tools to get significant strategic advantage not just to buyer-coalitions but also to sellers.

There are many advantages for both sellers and buyers in a market place to form coalitions. The sellers, by taking larger contracts, gain the advantage of statistical multiplexing, better planning of resource utilization over time, higher revenue from each contract, reduced administrative and management cost spent per contract. Buyers, small and medium size, benefit by obtaining considerable price discounts, more bargaining power, and by gaining access to larger sellers. Particularly across small and medium businesses, coalitions can provide a win-win for both customers and providers.

That is, service providers can benefit by taking larger contracts and obtaining statistical multiplexing, better planning of resource utilization over time, higher revenue from each contract, and lower management costs, since fewer, larger contracts to manage can reduce management costs. Management cost is often weakly dependent upon the size of the contract, so that managing ten $1M contracts requires roughly ten times the contractual and administrative efforts as managing a single $10M contract.

Customers benefit by obtaining volume discounts, thanks to the request size of the coalition, having more bargaining power to negotiate other non-price aspects of the contract, and gaining access to some providers who may not take on each customer individually.

There are many ways that coalitions can happen in e-markets.

For example, a first technique occurs by gathering demand from similar interest buyers, making use of this demand to reduce the price quoted by the seller. The “profit” (e.g., benefits or cost savings) generated to the buyer coalition can then be later shared among the coalition. These buyer coalitions are called “co-operatives” or “co-ops.” There are many popular co-ops on the Internet like, www.homeschoolbuyersco-op.org and www.letsbuyit.com, although the homeschoolbuyersco-op is perhaps better described as being a platform to place large orders so that individual buyers can have the benefit of getting a volume discount due to the aggregated orders.

FIG. 1 exemplarily shows this method 100, wherein a user first identifies a service in step 101, fills out a form in step 102, which is then published as a request for quote (RFQ), in step 103. In step 104, one or more suppliers respond to the RFQ. In step 105, the service provider matches the vendor responses to the user, so that the user receives one or more quotes in step 106.

A second set of techniques offers both seller and buyer coalitions and suitable discounts for both the sides. There are many websites that offer this capability using private and public deal-room capabilities, such as http://www.e-winwin.com, using their trademark demand aggregation facility.

However, historically, there is no way for a seller to predict with certainty the sale price of the product in order to increase the sales volume of the product by a specified amount. The estimation techniques used for determining the price for a product use the sales data that does not include the number of buyers who declined the purchase due to high price or other quality/feature factors. Similarly, from the buyer point-of-view, the buyer is not aware of the coalitional buying power/capacity that is available in the market at the time of a product purchase.

There are many techniques that solve this problem by providing a first-hand opportunity for buyer and seller to form coalitions. For example, electronic trading companies like http://www.e-winwin.com provides demand aggregation facility using their SynchroBuys™ mechanism.

Yet, both www.e-winwin.com and other e-markets lack the ability to communicate to the buyer and seller any potential coalitions with further negotiation options to improve their profit margin. Moreover, there is no price bargaining available in the mechanism, such as defined by e-winwin, since prices are determined by the volume price structure of the seller, and buyers do not have any control of the structure.

In another categorization of conventional coalition formation, mechanisms might be based on whether the mechanism is similar to a manual coalition formation, as exhibited at the webside http://www.eBPO.in, wherein are listed vendors by industry and functions, and the user would seek a specific vendor, such as Accenture, IBM, Hewlett Packard, Dell, EDS, etc., for possible coalition formation opportunities. In contrast, a semi-automatic category is exhibited at website http://www.vendorseek.com, which can provide a quote to buyer for a service from various vendors. An automatic category is demonstrated at http://www.ewinwin.com, wherein orders are automatically grouped with orders with other buyers for potential discounts. (Synchro Buys™)

Thus, a need exists to improve the mechanism to assist sellers and buyers to form coalitions.

### SUMMARY OF THE INVENTION

In view of the foregoing, and other, exemplary problems, drawbacks, and disadvantages of the conventional systems, it is an exemplary feature of the present invention to provide a structure (and method) to assist sellers and/or buyers to form better coalitions by providing a feedback mechanism in the coalition formation process.

In a first exemplary aspect of the present invention, described herein is a computerized method for coalition formation, including receiving one or more coalitional and/or service constraints; and providing a feedback mechanism for the coalition formation, as based on modifying at least one of the one or more coalitional and/or service constraints.

In a second exemplary aspect, also described herein is an apparatus including a memory to store at least one of coalitional and service constraints proposed by at least one buyer and at least one seller; and a calculator to provide a feedback mechanism for a coalition formation based on the at least one of coalitional and service constraints.

The present invention defines a Coalition Service Provider (CSP) that offers the formation of buyer coalitions and/or seller coalitions, including methods for coalition expansion (and/or reduction) through re-negotiation to improve a benefit for a seller and/or a buyer. It also includes heterogeneous-parameter-based coalitions, CSP-originated incentives, as well as seller-specific buyer-side coalition constraints.

### BRIEF DESCRIPTION OF THE DRAWINGS

The foregoing and other purposes, aspects and advantages will be better understood from the following detailed description of an exemplary embodiment of the invention with reference to the drawings, in which:

FIG. 1 shows exemplarily a conventional method 100 of forming coalitions in e-commerce;

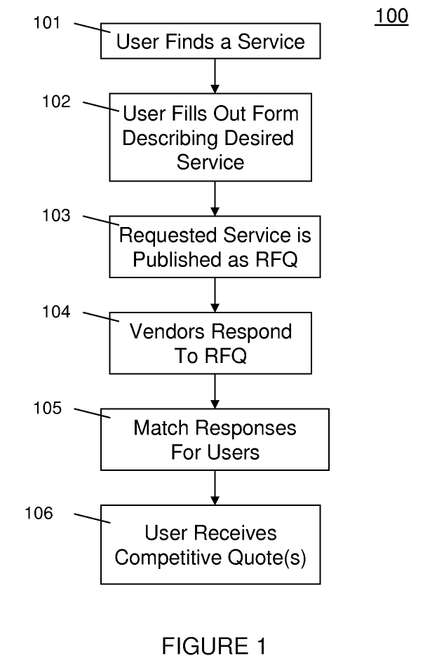

FIG. 2 shows exemplarily in flowchart format the method 200 of the present invention, wherein feedback loop 205 provides a relaxation mechanism to the coalition formation process;

FIG. 3 shows in high-level format an exemplary embodiment 300 of the method of the present invention;

FIG. 4 shows one exemplary embodiment of a formulation 400 for phase 1 301 shown in FIG. 3;

FIG. 5 shows exemplarily an embodiment 500 of the coalition expansion/reduction phase of the present invention corresponding to phase 3, shown in FIG. 3 as step 303;

FIG. 6 shows exemplarily a block diagram 600 of a software tool that would implement the concepts of the present invention;

FIG. 7 illustrates an exemplary hardware/information handling system 700 for incorporating the present invention therein; and

FIG. 8 illustrates a signal bearing medium 800 (e.g., storage medium) for storing steps of a program of a method according to the present invention.

### DETAILED DESCRIPTION OF EXEMPLARY EMBODIMENTS OF THE INVENTION

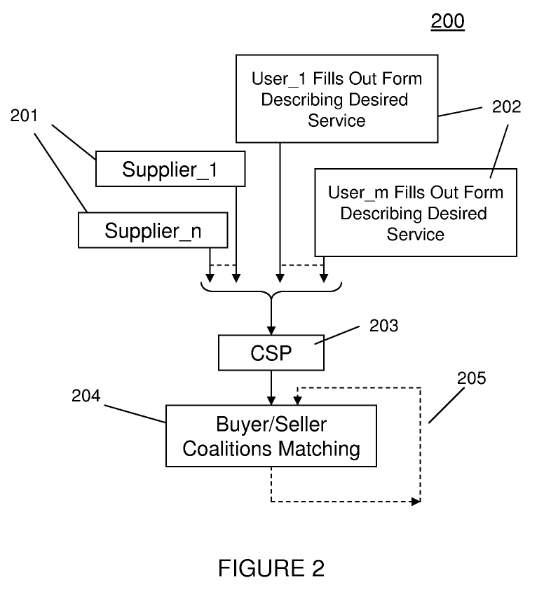

Referring now to the drawings, and more particularly to FIGS. 2-8, exemplary embodiments of the method and structures according to the present invention will now be explained.

The present invention focuses specifically on the e-markets that have been leveraging buyer and seller coalitions to provide various discounts, but the concepts can be applied more generally. The present inventors have recognized that, since the buyers and sellers in any market place will not be aware of their individual benefits against their set of announced buy/sell constraints, the set of constraints announced would be mostly selfish and would be intended to maximize their individual utility, thereby inherently fostering non-cooperation. The inventors have also realized that, when a coalition is formed, it would be rational for the seller/buyer to consider relaxing certain constraints in order to get significant profit/cost improvements, thereby also improving the overall utility for the e-market owner.

Moreover, in reviewing the literature and various patents and companies, the present inventors realized that current techniques do not offer such capabilities as the formation of heterogeneous service coalitions, iterative coalition expansion (or, in some cases, reduction) through re-negotiation of seller and buyer coalitions, qualitative/performance constraints for service for buyers and sellers, or discounts for relaxing service/coalitional discounts.

Thus, the present inventors have recognized that all these various marketplaces that are currently available have in common been lacking a feedback system through which buyers and sellers can change the proposed (or arrived) coalition. A feedback system described by the present invention is essentially a mechanism to relax coalitional and service constraints initially proposed by the buyers and the sellers.

The present invention provides such feedback system to maximize the benefits for seller, buyer, and/or e-market owner.

In the exemplary embodiment 200 shown in FIG. 2, this is a guided feedback mechanism 205, where the system provides a feedback to sellers and buyers with their advantages for relaxing/tightening coalitional and service constraints. In this process, the model can also suggest an increase in profit to the e-market owner (e.g., the Coalitional Service Provider).

Thus, in FIG. 2, n suppliers 201 and m buyers 202, where n and m are integers, have communicated to the CSP 203, such that the CSP 203 can match requests from buyers with quotes from suppliers in step 204, to thereby begin the coalition formation process. Feedback loop 205 is used so that the initial coalition is then selectively optimized, in any of various possible directions as dependent in large part upon the formulation of the initial coalition. Coalition 206 results if all parties ultimately decide on a final coalition.

Key Terms
Buyer—One who is interested to buy a product or service through a coalition.
Seller—One who is interested to sell a product or service through a coalitions.
Coalition Service Provider (CSP)—One who owns or operates the website or e-marketplace or web clearing house, or otherwise makes available such services as described herein. The CSP matches the service requirements from different buyers (sellers) under coalitional constraints and comes up with possible coalitions of buyers and/or sellers which act as a “virtual buyer” or “virtual seller.” The CSP would typically charge a fee to each buyer (seller), or at least one or more of the buyers or sellers. As non-limiting examples, the fee could be proportional to the net savings in a deal for a buyer due to coalition or could be proportional to the payment amount.

The CSP could also offer incentives for buyers (sellers) to relax their service and/or coalition requirements, if gain is possible based on an initial set of requirements, and as accomplished by a re-negotiation step. That is, less stringent coalitional constraints would typically provide a larger set of potential coalition partners, which results in a larger coalition size and the resultant higher benefits of volume-pricing. Less stringent SLA (Service Level Agreement) constraints would provide a larger set of potential sellers that can offer that service, which would result in more bargaining power for that coalition.

Generally, coalition expansion is preferred. However, in some cases, when the binding constraints are provider capacity, coalition reduction may be more beneficial.

The CPS may also provide incentives to the seller to restructure their services offering (price and SLAs) so as to expand the coalition size.

Although the exemplary embodiment describes the CSP as a web-based entity, the concept is clearly not so limited.

Service Constraints—Includes one or more parameters, such as security, throughput, delay, availability, interoperability with existing infrastructure, and quantitative metrics that quantitatively define a characteristic of a service considered important by at least one party involved in the potential coalition.

Coalitional Constraints—Includes one or more parameters, such as size of coalition partners, physical territory, demographics of the market, past experience, credit rating, and quantitative and qualitative metrics that quantitatively define a characteristic of the proposed coalition in some manner that is considered important by at least one party involved in the potential coalition. • Seller-specific Buyer-side Coalition Constraints—Coalition and service attributes defined by a buyer can be seller-specific, such as “Buyer X interested only in Sellers Y and Z.”

Heterogeneous services—In the academic literature, coalition formation is based on price reductions due to volume discounts. In the case of manufactured products, this is the defining feature. For services, such as outsourcing, QoS (Quality of Service) and characteristics of the service are equally important. In the present invention, a coalition's members may have different QoS requirements for different types of outsourced services: IT, Accounting, HR, etc.

System Flow

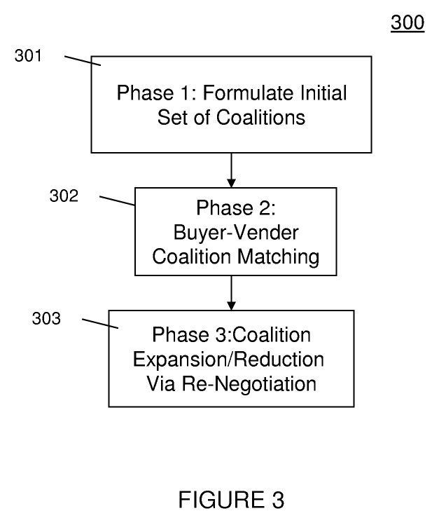

FIG. 3 shows an exemplary high-level system flow 301 of the solution of the present invention in accordance with an exemplary first embodiment.

In Phase 1, 301, one or more buyers and/or sellers submit forms specifying the attributes of the service required/provided and the possible coalitions. These attributes form the service and coalition constraints previously mentioned. Phase 1 includes processing by the Coalition Service Provider (CSP) to find an initial set of coalitions (buyer coalitions and seller coalitions). As part of determining the initial set of coalitions, one of various possible formulations, described in more detail below, is chosen to serve as a guide upon which to base possible coalitions.

It is noted at this point that the discussion above defined service constraints and coalitional constraints, but it should be clear that the concept of the present invention includes having any number and combination, including a single service constraint and/or a single coalitional constraint. Therefore, it is appropriate to consider that there is one or more service and/or coalitional constraints in the method of the present invention.

In Phase 2, 302, the CSP matches the optimal buyer-seller coalitions.

In Phase 3, 303, the CSP offers coalition/performance relaxation suggestions to sellers and buyers to maximize their profit. This aspect is a key feature of the present invention that distinguishes it from prior art coalition formation techniques.

Principal Notations

Before proceeding to the details of system flow, the notations are introduced, as follows: # of Buyers B, and set of Buyers B

# of Sellers S, and set of Sellers S

(Required) Service constraints of buyer b:{bₚⁱ, i=1, . . . , M}

Coalition constraints of buyer b:{b_{c}ⁱ,i=1, . . . , N}

(Offered) Service constraints of seller s:{sₚⁱ, i=1, . . . , M}

Coalition constraints of seller s:{s_{c}ⁱ,i=1, . . . , N}

Price charged to buyer b by CSP in coalition x:p_{b}¹(x)

Price charged to seller s by CSP in coalition y:pₛ²(x)

Per unit cost of service to buyer b in coalition x:c_{b}(x)

Total cost of service to buyer b in coalition x:p_{b}¹(x)+c_{b}(x)L_{b}

L_{b} is the service demand of buyer b

Service received by buyer b in coalition x, { b̅ₚⁱ(x),i=1, . . . , M}

Coalition Constraints

In an exemplary embodiment, buyers and sellers are identified by a tuple: (service constraints, coalition constraints). As previously discussed, service constraints includes such factors as security, throughput, delay, availability, interoperability with existing infrastructure, and other quantitative metrics.

Coalition constraints include such factors as the size of coalition partners, physical territory, demographics of the market, past experience, credit rating, and quantitative and qualitative metrics.

Coalitional constraints partition the set of potential coalition partners for buyer b, as follows.

Set of available coalition partners: B\b

Set of feasible (satisfying coalitional constraints) coalition partners: B_{b}, B_{b}∪B_{b}^{c}=B\b

System Flow Details

Returning now to FIG. 3, an exemplary embodiment 300 of the present invention includes three phases.

Phase 1—Determine Coalitions (Buyer and Seller)

The purpose of Phase 1 is the selection of the guidelines used to actually calculate the members of a proposed coalition. There can be more than one formulation that could be used by the CSP to determine which buyers and sellers could form a coalition. It is noted at this point that there is not necessarily a single coalition. Rather, instead of a single coalition for all the buyers who submitted service requests, the buyers might be grouped into a set of possible coalitions. A single coalition for all the buyers might not even be feasible, because of service and coalition constraints.

That is, an intent of this phase is to explore all the possible coalitions and the benefits for a buyer when participating in them. So, it only makes sense to explore all potential coalitions possible. In going to a more granular level, the present invention can also allow the flexibility of a buyer splitting his total demand across multiple feasible coalitions.

The sellers can also form coalitions analogously to those discussed for potential buyer coalitions. The seller coalition forming can be either done in response to a service demand from a buyer or a coalition of buyers posted by CSP or it can be done offline, independently of the demand.

Following is a non-limiting exemplary proposed set of such sample formulations, two of which are described in detail.

Formulation 1: Total cost to set of all buyers minimized;

Formulation 2: Total revenue to CSP maximized;

Formulation 3: Generalized profit (price, quality) maximized;

Formulation n: Other similar linear program min/max problem that can be defined by a cost function related to coalition formation.

Formulation 1: Total Cost to Set of all Buyers Minimized

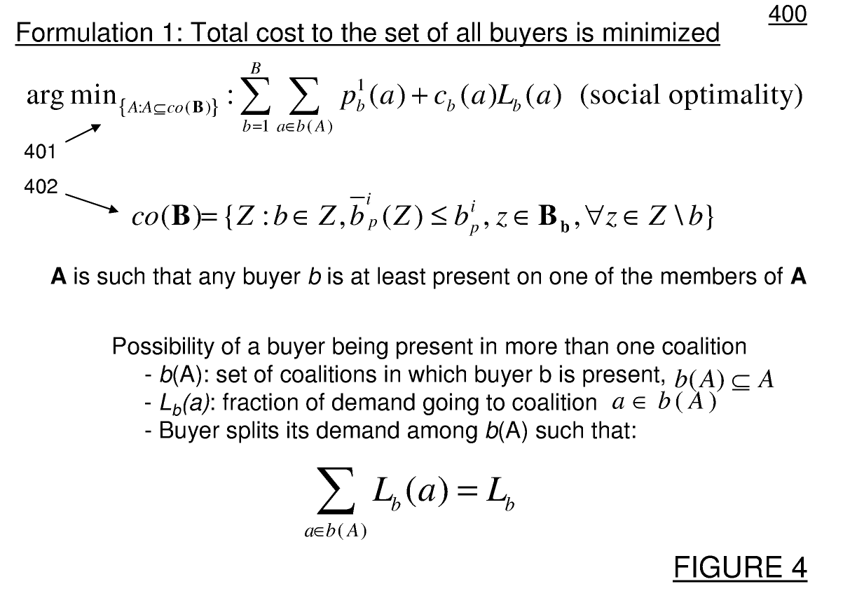

In this exemplary formulation 400 shown in FIG. 4, the total cost to the buyer coalition is minimized, using optimization equation 401, which provides a “socially optimal” solution by minimizing the total cost of all the buyers. Equation 402 defines co(B), which is the set of feasible coalitions of B buyers under the service constraints and coalition constraints. Equation 401 is the total service cost for all the buyers. Service cost for a buyer b is the sum of the price paid to CSP for its service and the price charged by the seller. If the buyer sends L_{b}(a) units of its demand to seller a and the price per unit service charged by seller a from buyer b is c_{b}(a), then the total cost of service (excluding the CSP price) is c_{b}(a)·L_{b}(a).

Formulation 2: Total Revenue of CSP is Maximized

In this second exemplary formulation, the focus is to maximize the revenue for the CSP in determining the coalition for buyers (sellers). An exemplary formulation function is:

$$arg {max}_{\{ A \text{:} A ⊆ co ( B ) \}} : {\sum }_{b = 1}^{B} {\sum }_{s = 1}^{S} {\sum }_{\{ a \text{:} a ∈ A , A ⊆ co ( B ) \} , \{ c \text{:} c ∈ C , C ⊆ co ( S ) \}} [ {p}_{b}^{1} ( a ) + {p}_{s}^{2} ( c ) ]$$

The revenue of a CSP is the sum of the price paid by the buyers and sellers to him. The price charged by CSP from buyer b is p_{b}¹(a) when the buyer is a member of buyer coalition a and the price charged by CSP from seller s is pₛ²(c) when the seller is a member of seller coalition c.

co(S) is the set of feasible coalitions of S sellers under service and coalition constraints.

Other possible phase 1 formulations might include, for example, one or more of incorporating seller information during coalition formation, maximizing aggregate revenue from both buyers and sellers, as well as a combined problem of providing an optimal set of buyer coalitions and optimal set of sellers coalitions as well as a combined problem of providing a good set of buyer coalitions and seller coalitions, which could be accomplished by solving first for the optimal buyer coalitions, by using e.g. Formulation 1 and then solving for the optimal seller coalitions, e.g. using Formulation 2. In order to combine the two sets of what is likely to be different coalitions, some compromise set can be determined according to a third criterion.

Phase 2—Buyer Vendor Coalition Matching

In an exemplary embodiment, a standard bi-partite matching algorithm is used to match the vendors and sellers. The augmenting path algorithm is a classic approach to solving this problem. In that algorithm, paths are successively added from vendors to sellers. When the weights of the matches between buyers and sellers differ, i.e. the preferences differ, then the Hungarian algorithm can be used to solve it.

Phase 3—Coalition Expansion or Reduction Through Re-Negotiation

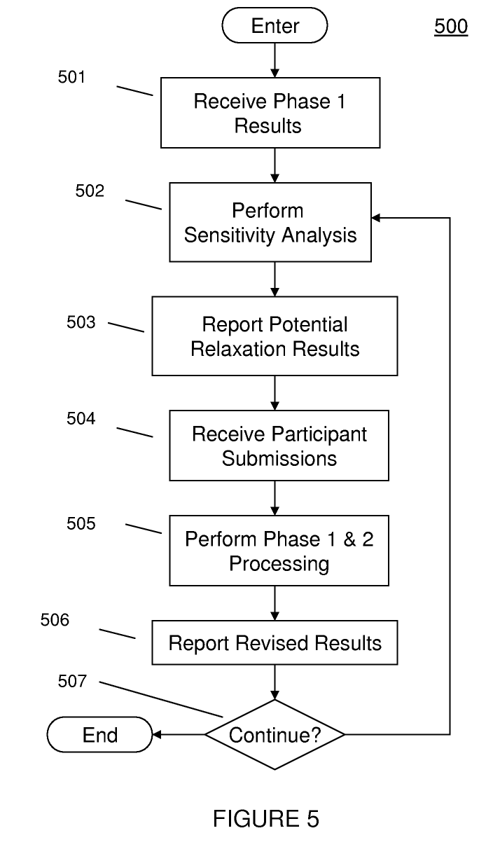

FIG. 5 demonstrates an exemplary embodiment 500 for the feedback mechanism for coalition expansion/reduction processing. In step 501, data from the results of the initial Phase 1 and Phase 2 coalition formation are received.

In step 502, a sensitivity analysis is performed on this coalitional/quality initially resultant from Phase 1. For example, Lagrange multipliers of each constraint can be used to give marginal benefit available from relaxing one constraint by one unit. The most advantageous (excluding any which are not able to be relaxed) solution is determined as the output of this step 502 and could be proposed to the currently-defined-coalition members, in an effort to gain higher benefit.

Thus, in step 503, the relaxation benefits are reported to participants. In step 504, any inputs from participants are received, and, if appropriate, based on the new submissions, Phase 1 model processing is executed in step 505, using updated constraints, followed by Phase 2 processing. Phase 1 model can be resolved with minimal effort from previous solution and using the new constraints.

In step 506, the updated coalitions are reported to participants, and the decision node at step 507 permits the process to be repeated as many times as required.

Thus, in summary, the present invention provide a novel method of forming coalitions that exemplarily includes a CSP that offers formation of buyer coalitions and/or seller coalitions with a method for coalition expansion (and/or reduction) through re-negotiation to improve the benefits for seller and/or buyer. It also provides for heterogeneous-parameter-based coalitions, seller-specific buyer-side coalition constraints, and CSP-originated incentives, wherein the CPS may provide incentives to the seller to restructure their services offering (price and SLAs) so as to expand the coalition size.

Exemplary Software Implementation

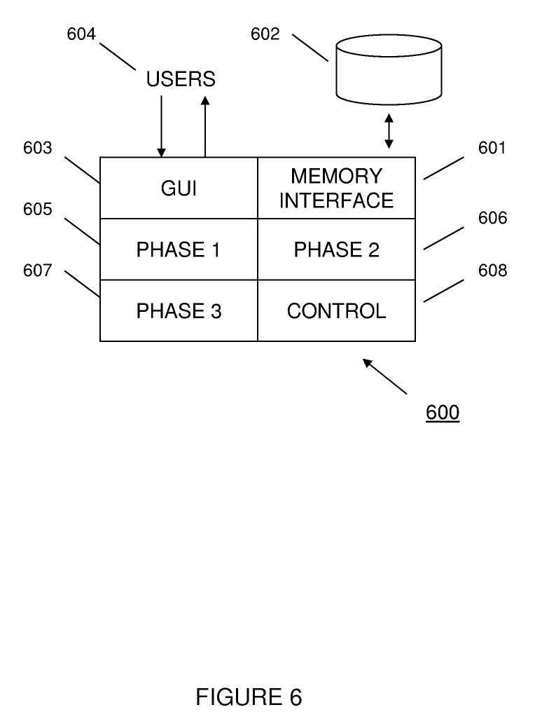

FIG. 6 illustrates a typical block diagram 600 of an exemplary software implementation of the present invention, whether implemented as a standalone application program or as embedded in a larger application program. Memory interface 601 provides the interface with memory 602 for retrieving and storing data used in the coalition formation processing. Graphical User Interface 603 permits interface with a user 604. Software modules 605-607 execute the processing for the three modules described above, and control module 608 provide a main function to control the different software modules, which typically would be subroutines invoked by the main function module 608.

Exemplary Hardware Implementation

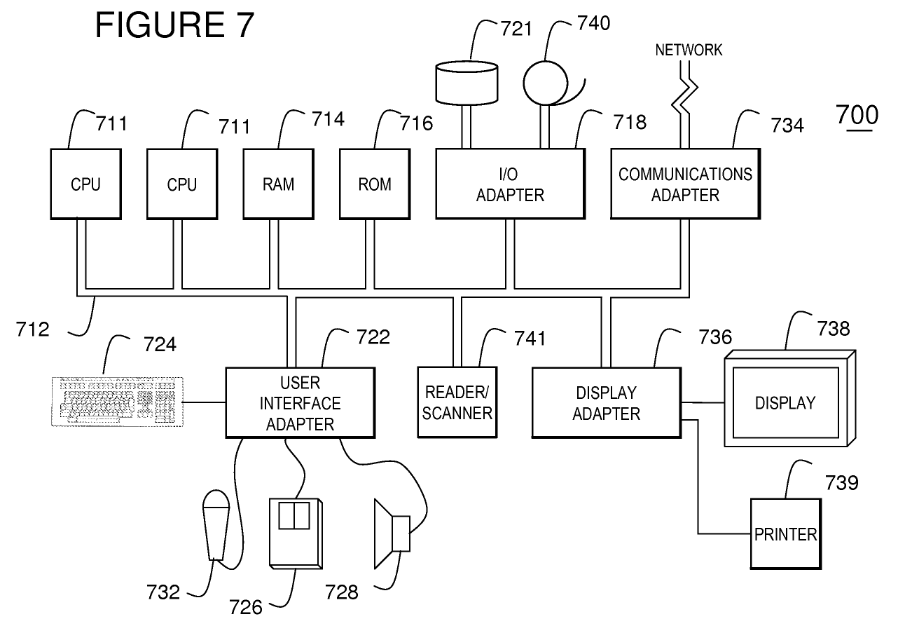

FIG. 7 illustrates a typical hardware configuration of an information handling/computer system in accordance with the invention and which preferably has at least one processor or central processing unit (CPU) 711 with one or more associated caches such as an L1 or L2 cache.

The CPUs 711 are interconnected via a system bus 712 to a random access memory (RAM) 714, read-only memory (ROM) 716, input/output (I/O) adapter 718 (for connecting peripheral devices such as disk units 721 and tape drives 740 to the bus 712), user interface adapter 722 (for connecting a keyboard 724, mouse 726, speaker 728, microphone 732, and/or other user interface device to the bus 712), a communication adapter 734 for connecting an information handling system to a data processing network, the Internet, an Intranet, a personal area network (PAN), etc., and a display adapter 736 for connecting the bus 712 to a display device 738 and/or printer 739 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 711 and hardware above, to perform the method of the invention.

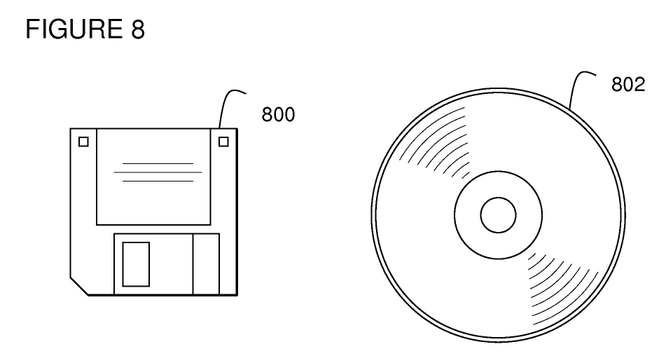

This signal-bearing media may include, for example, a RAM contained within the CPU 711, as represented by the fast-access storage for example. Alternatively, the instructions may be contained in another signal-bearing media, such as a magnetic data storage diskette 800 (FIG. 8), directly or indirectly accessible by the CPU 711.

Whether contained in the diskette 800, the computer/CPU 711, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards. Other suitable signal-bearing media, including transmission media such as digital and analog and communication links and wireless, could also be involved. In an illustrative embodiment of the invention, the machine-readable instructions may comprise software object code.

Exemplary Service Implementations

In yet another aspect of the present invention, it should be apparent that the method described herein has potential application as the basis for a service. In this aspect, a business entity would typically offer the method of the present invention to the public, typically via the Internet, and typically would offer this service with some type of service charges. As previously mentioned, the CSP fee might be based upon charge a fee to one or more buyers or one or more sellers. A fee arrangement might also be proportional to the net savings in a deal for a buyer due to coalition or could be proportional to the payment amount. The CSP could also offer incentives for buyers (sellers) to relax their service and/or coalition requirements.

It should also be clear that the present invention might also be used by an entity, such as a buyer or seller, attempting to use coalitions as one potential marketing strategy, so that the present invention becomes another tool for use in allowing this entity to define its optimal marketing strategy when involving coalitions. In this implementation, the entity would not charge a fee for its service in coalition optimization.

Thus, the present invention provides a number of benefits including those listed above. In an exemplary embodiment, the primary operating environment for this invention would be the Internet, but the method is clearly applicable in other environments.

While the invention has been described in terms of various exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A computerized method for coalition formation, said method comprising:
receiving one or more coalitional and/or service constraints; and
providing a feedback mechanism for said coalition formation, as based on modifying at least one of said one or more coalitional and/or service constraints.

2. The method of claim 1, said feedback mechanism comprising a capability for at least one of a coalition expansion and a coalition reduction compared to a coalition that would have resulted from said one or more coalitional and/or service constraints.

3. The method of claim 2, wherein said one or more coalitional and/or service constraints are proposed by a potential buyer or seller, and said feedback mechanism comprises selectively proposing to relax at least one of said one or more initially proposed coalitional and/or service constraints.

4. The method of claim 3, wherein a determination of said selectively proposing to relax coalitional and/or service constraints comprises:
performing a sensitivity analysis to calculate marginal benefits of one or more constraints of a current coalition or a currently-proposed coalition;
determining which marginal changes would be optimal to perform; and
reporting said determined optimal marginal changes.

5. The method of claim 3, wherein said coalition formation is selectively based on one of a plurality of alternative formulations, said method further comprising:
receiving an input from a user to select which of said alternative formulations are to be implemented for formulating a proposed coalition.

6. The method of claim 1, as comprising a service provided by a computer on a network, said computer providing a capability for coalition formation among buyers and sellers with a service of a potential coalition expansion and/or reduction.

7. The method of claim 4, wherein said feedback mechanism selectively iterates said selectively proposing to relax coalitional and/or service constraints.

8. The method of claim 1, wherein said coalitional and/or service constraints comprise heterogeneous-parameter-based coalition definitions.

9. The method of claim 1, wherein a Coalition Service Provider (CSP) makes available a service for said coalition formation for buyers and sellers, said CPS selectively providing CSP-originated incentives for restructuring said coalition.

10. The method of claim 1, wherein said coalitional and/or service constraints selectively include seller-specific buyer-side coalition constraints, wherein coalition and service attributes defined by a buyer can be seller-specific.

11. A computer-readable medium tangibly embodying a program of machine-readable instructions executable by a digital processing apparatus to perform a computerized method of claim 1.

12. The computer-readable medium of claim 11, as comprising one of:
machine-readable code on a hard drive of a computer serving as a server on a network for downloading said machine-readable code to another computer on said network or a hard drive of a computer in preparation for executing said computerized method;
machine-readable code on a computer currently executing said computerized method; and a
standalone diskette storing said machine-readable code, said standalone diskette capable of being inserted into a drive of a computer for downloading said machine-readable code onto said computer.

13. An apparatus, comprising:
a memory to store one or more coalitional and/or service constraints; and
a calculator to provide a feedback mechanism for a coalition formation, as based on said one or more coalitional and/or service constraints.

14. The apparatus of claim 13, wherein said feedback mechanism comprises a capability for at least one of a coalition expansion and a coalition reduction, and wherein said one or more coalitional and/or service constraints are proposed by a potential buyer or seller, and said feedback mechanism comprises selectively relaxing at least one of said one or more coalitional and/or service constraints initially proposed by the buyer or seller.

15. The apparatus of claim 14, wherein said selectively relaxing comprises:
performing a sensitivity analysis to calculate marginal benefits of one or more constraints of an existing coalition or proposed coalition;
determining which marginal changes would be optimal to perform; and
reporting said determined optimal marginal changes.

16. The apparatus of claim 13, further comprising a receiver to receive an input from a user to select which of alternative formulations are to be implemented for formulating a proposed coalition.

17. The apparatus of claim 13, as comprising a computer on a network, said computer providing a capability for coalition formation among buyers and sellers with a capability for coalition expansion and/or reduction.

18. The apparatus of claim 13, wherein said feedback mechanism selectively iterates said selectively relaxing of coalitional and/or service constraints.
